(19) United States
(12) Patent Application Publication
(10) Pub. No.: US 2024/0360815 A1
(43) Pub. Date: Oct. 31, 2024

(54) COMPACT POWER GENERATOR FOR WIND TURBINE SYSTEM

(71) Applicant: WRIGHT STATE UNIVERSITY, Dayton, OH (US)

(72) Inventor: Junghsen LIEH, Dayton, OH (US)

(73) Assignee: WRIGHT STATE UNIVERSITY, Dayton, OH (US)

(21) Appl. No.: 18/646,303

(22) Filed: Apr. 25, 2024

Related U.S. Application Data
(60) Provisional application No. 63/461,971, filed on Apr. 26, 2023.

(51) Int. Cl. F03D 9/25; F03D 3/00; F16H 57/08

(52) U.S. Cl. CPC F03D 9/25; F03D 3/005; F16H 57/082; F16H 2057/085; F16H 2200/2005

(57) ABSTRACT

An efficient compact power generator system is provided. The system includes a shaft assembly, upper fan assembly, lower fan assembly, windmill opening assembly, bevel gear assembly, planetary gearset, and generator. The shaft assembly includes upper and lower shafts. The upper fan assembly includes an upper fan. The lower fan assembly includes a lower fan and bearings. The windmill opening assembly includes inlet and outlet openings. The bevel gear assembly includes a top bevel gear, a middle bevel gear, and a bottom bevel gear which are arranged and configured to reverse the direction of the lower fan to synchronize with the upper fan.

### RELATED APPLICATION

This application claims priority to U.S. provisional application 63/461,971, filed Apr. 26, 2023, the contents incorporated herein by reference in its entirety.

### FIELD OF DISCLOSURE

The present disclosure relates to an efficient compact power generator for a wind turbine system.

### BACKGROUND

Wind is generally considered a clean source of energy because it does not produce greenhouse gas emissions or other pollutants during operation. Unlike burning fossil fuels like coal or natural gas, which release harmful substances and carbon dioxide, wind turbines generate electricity solely by harnessing the movement of air, without any emissions.

Larger wind turbine blades have the potential to enhance the efficiency of wind turbines by capturing more wind energy. This is because the energy generated by a wind turbine is directly proportional to the area swept by the blades.

However, there are practical limitations of larger wind turbine blades, such as structural and logistical constraints, that must be considered when increasing blade size. The increased weight and length of larger blades can make manufacturing and transportation more challenging and costly. It can further limit locations where wind turbines can be installed. Installation of wind turbines with large blades in residential, household, rooftop, and off-grid locations would not be commercially viable.

In other approaches, small, compact wind turbine systems for power generation applications have been used for residential, household, rooftop, and/or off-grid locations. The use of these small wind turbines for home, residential, or commercial use can help achieve lower electricity usage/costs, provide an uninterrupted power source in the event of grid failure/blackouts, and realize zero emissions compared to hydrocarbon-based options. Estimates of electrical energy savings in a residential application for these small, home-based wind turbines range from 50%-90%. These so-called “mini or microturbines” can be divided into two major classes: horizontal axis and vertical axis. Horizontal-axis small wind turbines are the most commonly used and typically have two or three blades constructed of a composite material (e.g., fiberglass). Vertical-axis wind turbines include two types, for example, Savonius and Darrieus turbines. The Savonius turbine is configured in an “S” shaped design, and the Darrieus turbine is configured in a helix-shaped, disc-like, or an eggbeater shape with vertical blades rotating in and out of the wind. As with any type of wind turbine system, small turbine power output is a function of four major factors; prevailing wind speed at the rotor axis height or hub height, rotor swept area, overall system reliability, and total power conversion efficiency from wind to electricity. For small, state-of-the-art wind turbines in the 0.5-10 KW range, total electric efficiencies range from 50%-70%. Recently, annual sales of small wind turbines in the United States were 13,400 and could contribute up to 3%, or 50,000 MW of U.S. electric supply.

However, with regards to vertical-axis wind turbines, these systems mostly have only a single fan and have a “S” shaped design or a helix-shaped design which may decrease the efficiency of the wind turbine. In addition, since the blades can pass through an aerodynamic dead zone during their rotation, the blades are not always facing the wind in the most convenient orientation. In other words, the fan cannot rotate within a horizontal plane to capture wind energy from multiple directions.

Therefore, there remains a need for a small, compact wind turbine system for power generation capturing wind energy in multiple directions while without increasing the size of blades.

### SUMMARY

The present disclosure describes an exemplary efficient compact power generator system. In an exemplary embodiment, an efficient compact power generator system includes a shaft assembly, upper fan assembly, lower fan assembly, windmill opening assembly, bevel gear assembly, planetary gearset, and generator. The shaft assembly includes upper and lower shafts. The upper fan assembly includes an upper fan. The lower fan assembly includes a lower fan and bearings. The windmill opening assembly includes inlet and outlet openings. The bevel gear assembly includes a top bevel gear, middle bevel gear, and bottom bevel gear.

Other features and advantages of the present invention will be apparent from the following more detailed description of exemplary embodiments, taken in conjunction with the accompanying drawings, which illustrate, by way of example, the principles of the invention.

### BRIEF DESCRIPTION OF THE DRAWINGS

FIG. 1A illustrates a schematic view of an exemplary power generator system for a wind turbine, according to an example embodiment.

FIG. 1B illustrates a schematic view of an exemplary power generator system of FIG. 1A, according to an example embodiment.

FIG. 2A illustrates a schematic view of a top fan assembly with a windmill opening, according to an example embodiment.

FIG. 2B illustrates a schematic view of a bottom fan assembly with a windmill opening, according to an example embodiment.

FIG. 3 illustrates another schematic view of a windmill opening assembly and fan assembly of the system shown in FIG. 1A, according to an example embodiment.

FIG. 4 illustrates another schematic view of the system shown in FIG. 1A, according to an example embodiment.

FIG. 5 illustrates an upper perspective view of an exemplary planetary gearset of the system shown in FIG. 1A, according to an example embodiment.

FIG. 6 illustrates a perspective view of a bevel gear assembly of the system shown in FIG. 1A, according to an example embodiment.

FIG. 7 illustrates a schematic diagram of a generator of the system shown in FIG. 1A, according to an example embodiment.

FIG. 8 illustrates a schematic diagram of a power generator system 200 including a tail vane 210 according to an example embodiment.

It should be noted that these Figures are intended to illustrate the general characteristics of structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of regions and/or structural elements may be reduced or exaggerated for clarity. The use of similar or identical reference numbers in the various drawings is intended to indicate the presence of a similar or identical element or feature. Wherever possible, the same reference numbers will be used throughout the drawings to represent the same parts.

### DETAILED DESCRIPTION

Provided herein is an exemplary power generator system. Example embodiments of the present disclosure provide for a windmill power generator system with high efficiency and compact size, and the system may be located in various locations, including on building/structure rooftops, terrestrial, offshore areas, farms, etc.

Example embodiments of the present disclosure provide for a wind power generator system utilizing a two-fan design to increase turbine electricity production while not increasing the system's lateral/operational footprint. In some implementations, the second fan is configured to rotate to allow the compact windmill to generate electricity using a single fan or both fans, depending on the prevalent wind direction.

In some implementations, the compact power generator system includes two fans (i.e., an upper fan and a lower fan) on a shaft in a vertical orientation. The lower fan can be connected to a series of bevel gears, with the lowermost gear attached to a planetary gear set. The planetary gear set is attached to a second shaft connected to a power generator. The upper shaft terminates at its upper end above the upper fan in a worm gearset designed to automatically control the orientation of the upper and lower fans by controlling the direction of the windmill opening. The upper fan is fixed, while the lower fan can rotate in a horizontal plane along the shaft. The upper fan will rotate due to wind originating from the right side of the structure generating power. In contrast, the lower fan will rotate and generate power from wind originating from the opposite side of the structure (i.e., left). As the lower fan is attached to bevel gears, it will be capable of rotating horizontally to capture not only wind originating from the left side of the structure but also from the right side. When the lower fan has been rotated to capture wind from the right side of the structure, both fans are operating in series to increase unit power generation efficiencies.

In other implementations, the lower fan by way of the bevel gearset rotates the upper shaft in conjunction with the upper fan, in the same direction, in turn, increase the generation of power as compared with the power generated only by the upper fan. Therefore, by way of an additional inverse fan, the lower fan, and the windmill openings, the exemplary efficient compact power generator system can optimally harness wind energy by capturing and utilizing essentially all of the wind blowing in multi-directions to the compact power generator system.

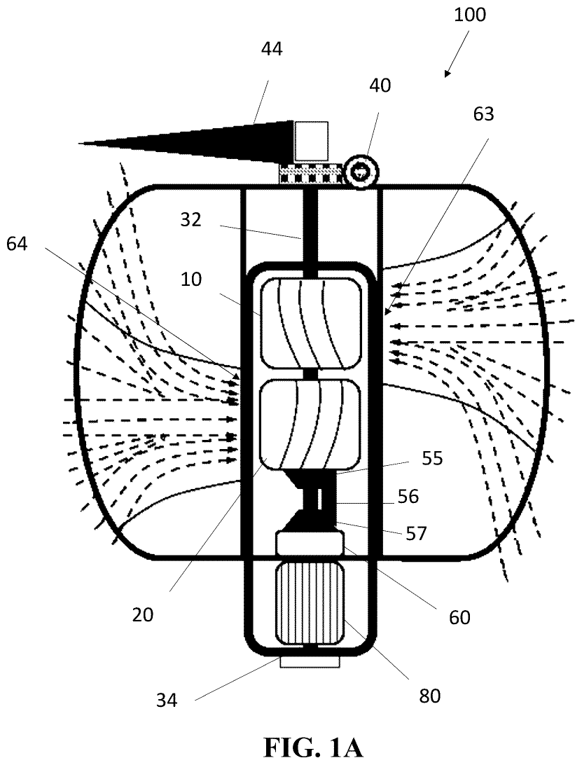

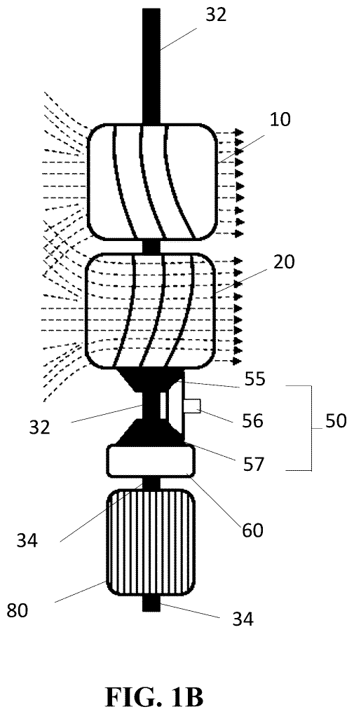

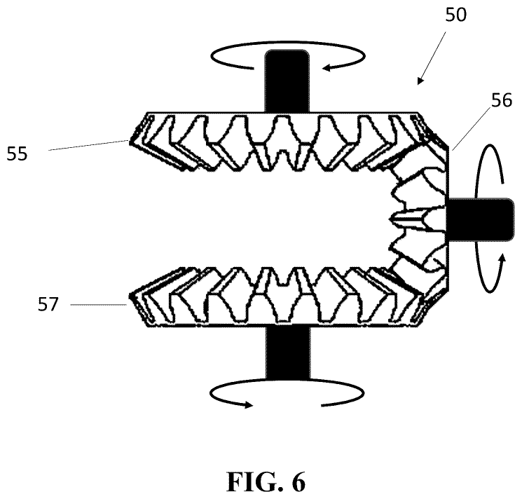

Referring to FIGS. 1A and 1B, in one example embodiment, a power generator system 100 is shown. The power generator system 100 includes two fans 10, 20 on shafts 32, 34 in a vertical orientation. In some implementations, the lower fan 20 is connected in series and located below the upper fan 10. The upper shaft 32 and lower shaft 34 are disposed vertically and coaxial to each other. The upper shaft 32 terminates at its upper end above the upper fan 10 and connected to a worm gearset 40. The worm gearset 40 is designed to automatically control windmill openings, in turn, to optimally harness wind energy via a wind tail 44 attached thereto. The lower fan 20 is connected to a set of gears 50 at its lower portion thereof. In one implementation, the set of gears 50 is a series of bevel gears 55, 56, 57, where bevel gear 56 engages both the bottom bevel gear 55 and the top bevel gear 57 causing reverse rotation (see FIG. 6). In other words, the bevel gearset 55, 56, 57 reverses lower fan 20 (to synchronize with upper fan 10) thus to drive a generator 80 in the same direction. The bottom bevel gear 57 is attached to a planetary gear set 60, which will be described in detail later.

In some implementations, the wind openings have inlet and outlet openings. Wind flows in through an inlet opening, spins the fans 10, 20, and flows out though the outlet opening. In one implementation, the wind openings have two inlet openings, the right side inlet opening 63 and the left side inlet opening 64. The wind flowing in through the right side inlet opening 63 drives the upper fan 10 while the wind flowing in through the left side inlet opening 64 drives the lower fan 20. As such, the upper fan 10 rotates the upper shaft 32, and the lower fan 20 rotates the top bevel gear 55.

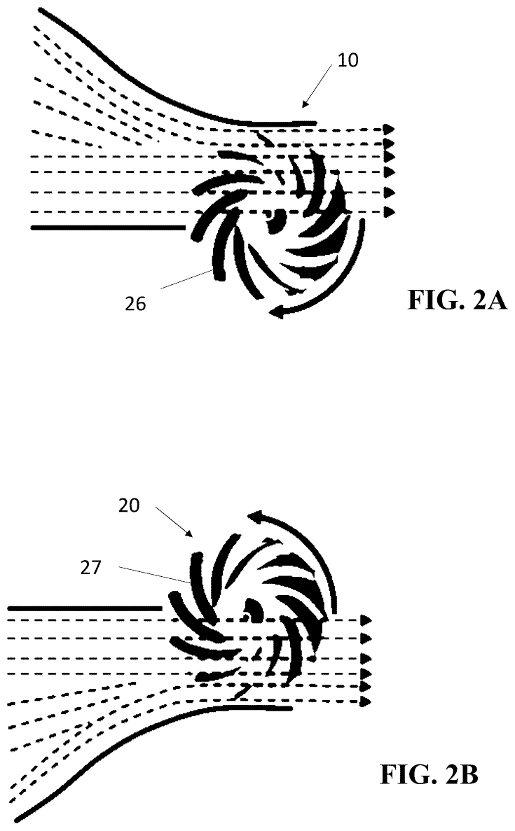

In some implementations, fans 10, 20 may include blades 26, 27 and be designed as airfoils, as shown in FIGS. 2A and 2B. The upper fan blades 26 and the lower fan blades 27 may be oriented differently. For example, the upper fan blades 26 may be upright airfoils (FIG. 2A), while the lower fan blades 27 may be inverted airfoils (FIG. 2A). Accordingly, due to the designs of the direction of blades 26, 27, each fan 10, 20 rotates in different directions. In some implementations, blades 26, 27 may be made of lightweight materials, such as composite materials or metal. The composite materials may include fiberglass or carbon fiber reinforced polymer and epoxy resin. The metal material may include aluminum. The size of blades 26, 27 may vary depending on the required capacity of the power generator systems.

Referring back to FIG. 1B, the upper fan 10 is fixed to the upper shaft 32, but the lower fan 20 is not directly fixed to the upper shaft 32 and is designed to be able to rotate about the upper shaft 32. For example, if wind flows through the right side inlet opening 63, the wind causes the upper fan 10 to spin clockwise (FIG. 2A). This spinning motion of the upper fan 10 rotates the upper shaft 32, in turn, causes the lower shaft 34 to rotate and drives the generator 80, by which the generator 80 converts the mechanical energy into electrical energy. In contrast, the lower fan 20 is designed to spin caused by wind from the opposite side inlet opening, i.e., the left side inlet opening 64. As a result, the lower fan 20 spins in the opposite direction, counterclockwise (FIG. 2B). Bearings are disposed between the lower fan 20 and the upper shaft 32 and allow the lower fan 20 to rotate about the upper shaft 32 such that rotation of the lower fan 20 does not directly cause the upper shaft 32 to rotate. In some implementations, bearings may be pitch bearings and main bearings, which are configured to allow the required oscillation for controlling the loads and power of the wind turbine.

When wind flows, through inlet openings, for instance, from the right side inlet opening 63 to the upper fan 10 and from the left side inlet opening 64 to the lower fan 20, the bevel gearset 55, 56, 57 function to reverse the lower fan 20 to synchronize the lower fan 20 with the upper fan 10, such that the upper fan 10 and lower fan 20 work in concert to drive the generator 80 in the same direction. That is, both fans 10, 20 are operating in parallel to increase unit power generation efficiencies.

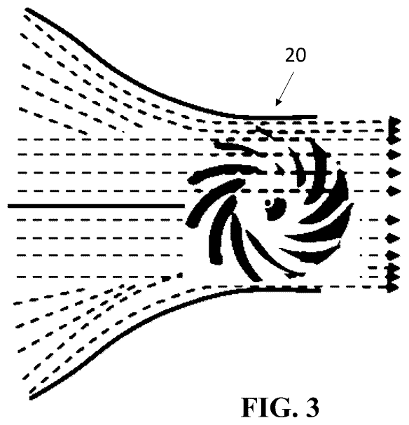

In some implementations, the lower fan 20 is attached to the top bevel gear 55, the top bevel gear 55 intersects with the middle bevel gear 56, the middle bevel gear 56 intersects with the bottom bevel gear 57, and the bottom bevel gear 57 is fixed to the upper shaft 32. If wind flows through the left side inlet opening 64, the wind causes the lower fan 20 to spin in the opposite direction (FIG. 2B) as compared with the upper fan 10 (FIG. 2A), for instance, counterclockwise, and the top bevel gear 55 spins with the lower fan 20 and rotates the middle bevel gear 56, for instance, clockwise (FIG. 6), in turn, the bottom bevel gear 57 rotates, for instance, clockwise, and eventually rotates the upper shaft 32, for instance, clockwise. Therefore, the lower fan 20 by way of the bevel gearset 50, i.e., the top bevel gear 55, middle bevel gear 56, and bottom bevel gear 57, rotates the upper shaft 32 in conjunction with the upper fan 10, in the same direction, in turn, increase the generation of power as compared with the power generated only by the upper fan 10. Therefore, referring to FIGS. 2A, 2B, and 3, by way of an additional inverse fan, the lower fan 20, and the windmill openings, the exemplary efficient compact power generator system 100 can optimally harness wind energy by capturing and utilizing essentially all of the wind blowing to the compact power generator system 100.

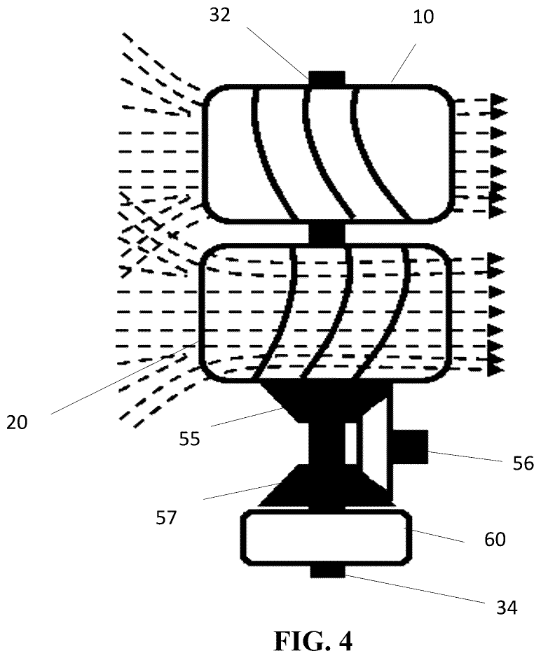

Referring to FIG. 4, in some implementations, bearings are used in conjunction with the bevel gears 55, 56, 57 that are configured to freely rotate about the upper shaft 32. For instance, as shown, top bevel gear 55 is mounted at the bottom of lower fan 20, by which, bearings of the top bevel gear 55 rotate freely on the upper shaft 32, in turn, the top bevel gear 55 turns the middle bevel gear 56 having two bearings rotating freely, then the bottom bevel gear 57. In one implementation, bottom bevel gear 57 uses one-way bearings to engage the upper shaft 32. That is, by way of example, one-way bearings are disposed between the bottom bevel gear 57 and the upper shaft 32, transmit torque between the bottom bevel gear 57 and the upper shaft 32 in one direction, and enable free motion in the opposite direction. It should be appreciated that more or less bearings can be employed besides the design configurations described herein.

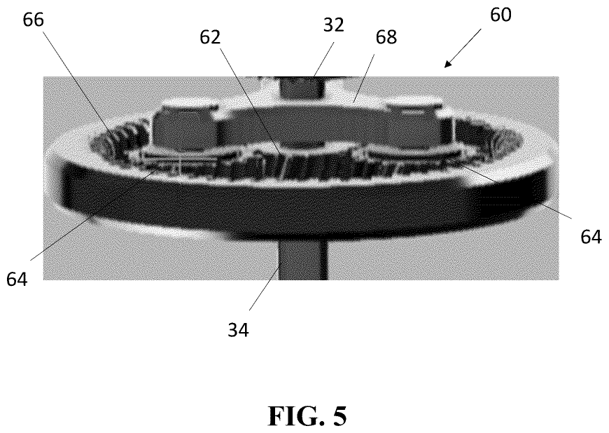

Referring to FIG. 5, in some implementations, the planetary gearset 60 may include a sun gear 62, a plurality of planet gears 64, a ring gear 66, and a carrier 68. The upper shaft 32 is attached to the carrier 68, wherein the carrier 68 is attached to the plurality of planet gears 64 such that the plurality of planet gears 64 rotate around axes that revolve around the sun gear 62, in turn, the sun gear 62 rotates in place. The sun gear 62 is attached to the lower shaft 34, which is connected to the generator 80.

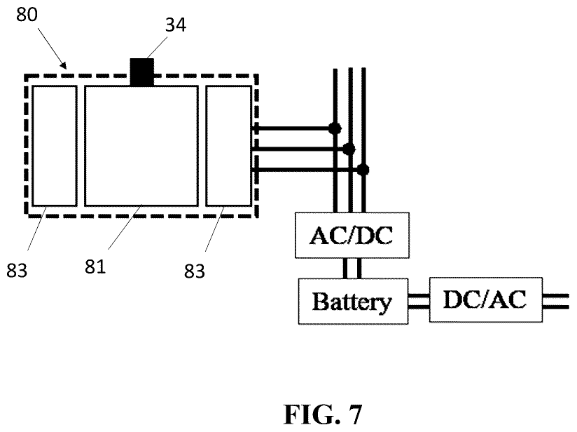

Referring to FIG. 7, in some implementations, the lower shaft 34 is connected to the generator 80. The generator 80 may include a rotor 81 and a stator 83 surrounding the rotor 81. The rotor 81 and the stator 83 work together to create electricity in the form of an alternative (AC) current. More specifically, the rotation of the rotor 81 generates electricity. When wind drives the upper and lower fans 10, 20 to spin, the fans 10, 20 cause the upper shaft 32 to rotate, in turn, cause the carrier 68 of the planetary gearset 60 to rotate, in turn, cause the sun gear 62 to rotate by way of the planetary gears 64, and the sun gear 62 rotates the lower shaft 34 which rotates the rotor 83 and generates electricity. Through this mechanism, the mechanical energy delivered by wind is converted into electrical energy.

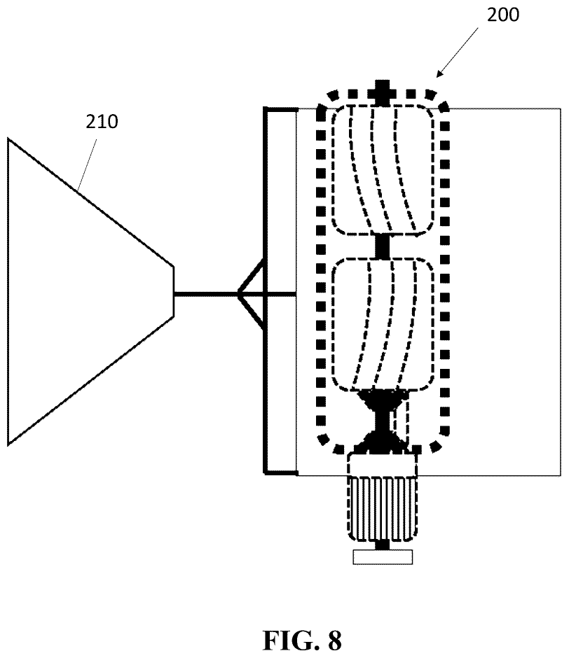

FIG. 8 illustrates a schematic diagram of a power generator system 200 including a tail vane 210 according to an example embodiment. Like parts are shown herein and not described further in detail. As shown, the tail vane 210 is a device of rigid, flat plate construction, which is attached at the rear of a movable body of a wind-power generator as a means of making the wind turn the rotor into the wind. In other words, to ensure that the wind blades are always facing directly the direction where the strongest wind is coming from. The tail vane 210 is generally used for automatic wind source steering.

The articles “a” and “an,” as used herein, mean one or more when applied to any feature in embodiments of the present disclosure described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used. The adjective “any” means one, some, or all indiscriminately of whatever quantity.

“At least one,” as used herein, means one or more and thus includes individual components as well as mixtures/combinations.

The transitional terms “comprising”, “consisting essentially of” and “consisting of”, when used in the appended claims, in original and amended form, define the claim scope with respect to what unrecited additional claim elements or steps, if any, are excluded from the scope of the claim(s). The term “comprising” is intended to be inclusive or open-ended and does not exclude any additional, unrecited element, method, step or material. The term “consisting of” excludes any element, step or material other than those specified in the claim and, in the latter instance, impurities ordinarily associated with the specified material(s). The term “consisting essentially of” limits the scope of a claim to the specified elements, steps or material(s) and those that do not materially affect the basic and novel characteristic(s) of the claimed disclosure. All materials and methods described herein that embody the present disclosure can, in alternate embodiments, be more specifically defined by any of the transitional terms “comprising,” “consisting essentially of,” and “consisting of.”

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that, if an element is referred to as being “connected” or “coupled” to another element, it can be directly connected, or coupled, to the other element or intervening elements may be present. In contrast, if an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

Spatially relative terms (e.g., “beneath,” “below,” “lower,” “above,” “upper” and the like) may be used herein for case of description to describe one element or a relationship between a feature and another element or feature as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as, below. The device may be otherwise oriented (rotated 90 degrees or viewed or referenced at other orientations) and the spatially relative descriptors used herein should be interpreted accordingly.

Example embodiments are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments should not be construed as limited to the particular shapes of regions illustrated herein but may include deviations in shapes that result, for example, from manufacturing.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A power generator system, comprising:
a upper fan assembly including an upper fan, the upper fan fixedly attached to an upper shaft and configured to rotates in a first direction;
a lower fan assembly including a lower fan disposed vertically below the upper fan, the lower fan attached to the upper shaft and configured to rotate in a second direction opposite the first direction;
a bevel gear assembly including a top bevel gear, a middle bevel gear, and a bottom bevel gear, the top bevel gear attached to the lower fan and the upper shaft, the bottom bevel gear attached to the upper shaft, the top, middle, and bottom bevel gears arranged and configured to rotate the lower fan in the second direction; and
a generator attached to a lower shaft such that rotation of the lower shaft generates electricity,
wherein the upper fan and lower fan work in conjunction to drive the generator in the same direction.

2. The power generator system of claim 1, wherein the top bevel gear, the middle bevel gear, and the bottom bevel gear are arranged and configured such that the top bevel gear engage with the middle bevel gear and the middle bevel gear engage with the bottom bevel gear.

3. The power generator system of claim 2, wherein the middle bevel gear causes the top bevel gear to rotate in a first direction and the bottom bevel gear to rotate in a second direction opposite the first direction.

4. The power generator system of claim 2, wherein the middle bevel gear includes two bearings to engage with the top bevel gear and the bottom bevel gear.

5. The power generator system of claim 2, wherein the bottom bevel gear includes a one-way bearing engaged with the upper shaft, wherein the one-way bearing is disposed between the bottom bevel gear and the upper shaft to enable rotation in the second direction and to transmit torque between the bottom bevel gear and the upper shaft.

6. The power generator system of claim 1, further comprising a planetary gear set connected to the upper shaft and the lower shaft, wherein one end of the planetary gear set is attached to the upper shaft that is connected to the bottom bevel gear and the other end is attached to the lower shaft that is connected to the generator.

7. The power generator system of claim 6, wherein the planetary gear set includes a sun gear, a plurality of planet gears, a ring gear, and a carrier, wherein the upper shaft is attached to the carrier, the carrier is attached to the plurality of planet gears, and the plurality of planet gears rotate around axes that revolve around the sun gear in which the sun gear rotates in place.

8. The power generator system of claim 1, wherein a bearing is disposed between the lower fan and the bottom bevel gear, the bearing rotates freely on the upper shaft to cause rotation of the lower fan.

9. The power generator system of claim 1, wherein the upper and lower fans include blades, the blades of the upper fan include an upright airfoils causing the upper fan to rotate in the first direction and the blades of the lower fan include an inverse airfoils opposite the upright airfoils causing the lower fan to rotate in the second direction.

10. A power generator system, comprising:
a shaft assembly including an upper shaft and a lower shaft, the upper shaft and the lower shaft are disposed vertically and coaxially;
an upper fan assembly including an upper fan, the upper fan fixedly attached to the upper shaft;
a lower fan assembly including a lower fan and bearings, the lower fan being freely rotatable about the upper shaft;
a windmill opening assembly including inlet and outlet openings, the inlet openings including a right side inlet opening and a left side inlet opening, the right side inlet opening arranged and configured such that wind flows through the right side inlet opening causes the upper fan to spin to one direction, the left side inlet opening arranged and configured such that wind flows through the left side inlet opening causes the lower fan to spin in the opposite direction;
a bevel gear assembly including a top bevel gear, a middle bevel gear, and a bottom bevel gear, the top bevel, middle bevel, and bottom bevel gears being arranged and configured such that the top bevel gear engage with the middle bevel gear and the middle bevel gear engage with the bottom bevel gear; and
a generator, the generator attached to the lower shaft such that rotation of the lower shaft generates electricity,
wherein the upper fan and lower fan work in conjunction to drive the generator in the same direction.

11. The power generator system of claim 10, wherein the top bevel gear is attached to the lower fan and the bottom bevel gear is attached to the upper shaft.

12. The power generator system of claim 11, wherein the middle bevel gear causes the top bevel gear to rotate in a first direction and the bottom bevel gear to rotate in a second direction opposite the first direction.

13. The power generator system of claim 12, wherein the middle bevel gear includes two bearings to engage with the top bevel gear and the bottom bevel gear.

14. The power generator system of claim 11, wherein the bottom bevel gear includes a one-way bearing engaged with the upper shaft, wherein the one-way bearing is disposed between the bottom bevel gear and the upper shaft to enable rotation in the second direction and to transmit torque between the bottom bevel gear and the upper shaft.

15. The power generator system of claim 11, further comprising a planetary gear set connected to the upper shaft and the lower shaft, wherein one end of the planetary gear set is attached to the upper shaft that is connected to the bottom bevel gear and the other end is attached to the lower shaft that is connected to the generator.

16. The power generator system of claim 15, wherein the planetary gear set includes a sun gear, a plurality of planet gears, a ring gear, and a carrier, wherein the upper shaft is attached to the carrier, the carrier is attached to the plurality of planet gears, and the plurality of planet gears rotate around axes that revolve around the sun gear in which the sun gear rotates in place.

17. The power generator system of claim 10, wherein a bearing is disposed between the lower fan and the bottom bevel gear, the bearing rotates freely on the upper shaft to cause rotation of the lower fan.

18. The power generator system of claim 10, wherein the upper and lower fans include blades, the blades of the upper fan include an upright airfoils causing the upper fan to rotate in the first direction and the blades of the lower fan include an inverse airfoils opposite the upright airfoils causing the lower fan to rotate in the second direction.

19. The power generator system of claim 10, wherein the lower fan includes two bearings that rotate freely on the upper shaft to cause rotation of the lower fan.

20. The power generator system of claim 10, further comprising a worm gearset at an uppermost portion of the upper shaft to control the direction of the inlet openings.
